(19) United States
(12) Patent Application Publication
(10) Pub. No.: US 2016/0109094 A1
(43) Pub. Date: Apr. 21, 2016

(54) Decorative illuminable container

(71) Applicant: MinMor Industries LLC, Minneapolis, MN (US)

(72) Inventors: Jacqueline A. Magras-Sinnen, Maple Grove, MN (US); Jeffrey T. Murphy, Chanhassen, MN (US)

(21) Appl. No.: 14/887,584

(22) Filed: Oct. 20, 2015

Related U.S. Application Data
(60) Provisional application No. 62/066,540, filed on Oct. 21, 2014.

(51) Int. Cl. F21V 7/00

(52) U.S. Cl. CPC F21V 7/0008; F21W 2121/00

(57) ABSTRACT

An illuminable container having a reflective inner surface and at least one aperture of a selected shape wherein the container is configured to accept a light source and the effect of the reflective inner surface and light emitted from the light source is visible through the at least one aperture. The reflective inner surface may also have holographic properties. An outer surface of the container is printed with a design wherein the apertures and the design correspond such that a scene is formed when the container is illuminated. Alternatively, the illuminable container may comprise a shape and design configured to provide a dimensional aspect to the scene when illuminated.

### CROSS REFERENCE TO RELATED APPLICATION

The present application is based on and claims the benefit of U.S. provision patent application Ser. No. 62/066,540, filed Oct. 21, 2014, the contents of which are hereby incorporated by reference in their entirety.

### BACKGROUND

The present disclosure relates to reflective lighting containers and more specifically to decorative containers having holographic inner liners and/or selected openings for emitting light from light sources.

Traditionally, on holidays, people decorate their residence with novelties that may light up or be illuminated. The novelties are typically displayed on the ground or in windowsills or other areas where they may be viewed from at least a slight distance, for example, from a few feet away.

To illuminate many of these novelties, candles are typically placed inside a cavity. The illumination of the exterior of these novelties is relatively minuscule as the light eliminating from the novelty is simply projected outwards. Further, candles tend to have a lower luminous intensity such that the novelties would be subtly, or softly illuminated and thus the exterior of the novelties and any details, difficult to see.

While light bulbs provide more light, the light is harsh and directly projected outwardly from the inside of a novelty. Neither light source alone provides sufficient lighting in addition to a lighting effecting to fully illuminate the inside cavity and any outside design details of a novelty.

Moreover, traditional holiday novelties intended for illumination, comprise closed cavities and holes simply so the light from inside the closed cavity can be projected through the holes, providing a shadow effect. For example, with a jack-o-lantern illuminated from a candle placed inside, when viewed, what is visible is simply the shape of the face carved therein, or the shadow resulting therefrom.

### SUMMARY

An aspect of the present disclosure relates to an illuminable container having a reflective inner surface and at least one aperture of a selected shape, where the container is configured to accept a light source. The effect of the reflective inner surface and light emitted from the light source is visible through the at least one aperture. The reflective inner surface may also have holographic properties.

Another aspect of the present disclosure relates to a decorative illuminable container comprising a base configured to receive a light source and a plurality of sidewalls extending upward from the base to define an interior region. The sidewalls collectively define an outer surface and an inner surface for the container and the inner surface faces the interior region. The container further comprises a reflective liner disposed on the inner surface and a printed design applied to the outer surface. A plurality of apertures in at least one of the walls have shapes that correspond to the printed design applied to the outer surface. The container is configured to receive a light source in the interior region such that light from the light source reflects off the reflective liner and is emitted through the plurality of apertures. The reflective liner may comprise a holographic liner such that a holographic pattern is visible through the apertures.

Another aspect of the present disclosure further relates to an illuminable container having a visible dimensional aspect. A front vertical wall having a first shape and first height and an opposing rear vertical wall of a second shape and a second height different from the first shape and first height of the front wall are separated by a horizontal base extending there between. Opposing vertical side walls connect the front and rear walls. The side walls have a third shape and a third height different from both the first and second shapes and heights. The container further comprises a design applied to at least the front and rear walls and a plurality of apertures in at least one of the walls. The plurality of apertures each have a shape that corresponds to the design applied to the at least one wall. The rear wall extends above the front wall and the base is configured to receive a light source to illuminate a space above the base and bounded by the walls such that the design is illuminated and provides a dimensional aspect to the container.

Another aspect of the present disclosure further also relates to an illuminable open-top container, the container having a reflective inner surface and at least one aperture in a first vertical surface. The container further comprises at least one chad, or pop-out, in a second, adjacent vertical surface. The container is configured to accept a light source and the effect of the reflective inner surface and light emitted from the light source is visible through the at least one aperture.

Further, the reflective inner surface may be a holographic liner applied to the container such that a holographic pattern is visible through the apertures and reflected off an exposed surface of the chad when the container is illuminated. Moreover, such a container may be arranged with a plurality of like containers, each container having at least one aperture being any one of an alphanumeric character such that the containers when arranged, spell a word and when illuminated display the word with a holographic effect.

### DESCRIPTION OF THE DRAWINGS

FIG. 1 is a side perspective view of an illuminable container.

FIG. 2 is a top view of the illuminable container containing a lighting unit illuminated therein.

FIG. 3 is a left side perspective view of another illuminable container.

FIG. 4 is a front view of another illuminable container.

FIG. 5 is a back side perspective view of the illuminable container according to FIG. 4, with pop-out components folded outwardly.

FIG. 6 is a front view of a plurality of containers according to an embodiment of the present disclosure, which are arranged to spell the term “Boo!” and having the pop-out components stowed.

### DETAILED DESCRIPTION

The present disclosure is directed to an illuminable container having an open top and configured to hold a lighting unit therein. The container is further adapted with decorative elements including apertures of various shapes and sizes, as well as other elements integrated therein.

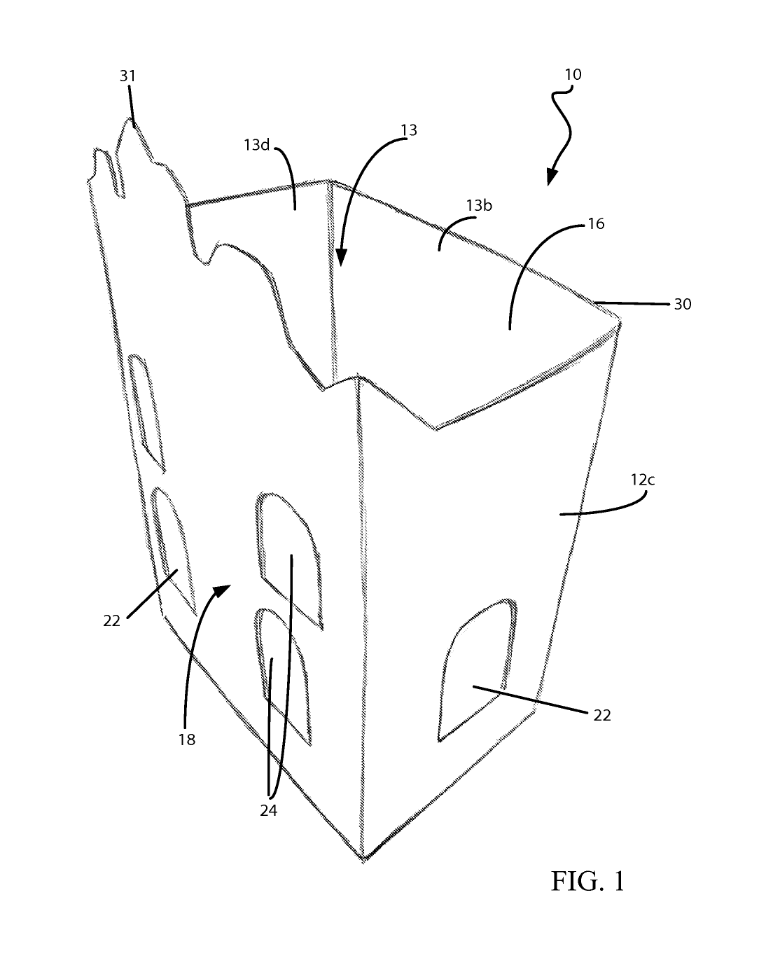

FIGS. 1-6 illustrate an open top container 10, which is an example of an illuminable container of the present disclosure. The container 10 is formed by a plurality of adjoining vertical side walls 12a, 12b, 12c and 12d extending upwardly from a horizontal base or floor 14. In the shown embodiment, the base 14 is square or rectangular in shape, and the side walls 12a-12d integrally extending upwardly from the base 14 such that the container 10 is generally rectangular in shape with respect to a vertical axis. The vertical side walls 12a-12d provide the perimeter of the container 10.

The base 14 of the container 10 provides a stable base for, and supports the container 10 in an upright and open position as illustrated in FIGS. 1-6. Within the perimeter of the container 10, the base 14 provides a surface for holding a lighting unit 28 for illuminating the container 10.

As shown, the vertical walls 12a-12d of the container 10 can have varying heights. For example, side walls 12c and 12d and back wall 12b extend upwardly to substantially the same height. Side walls 12c and 12d terminate with a substantially linear upper edge 30 extending along the back wall 12b and to the side walls 12c and 12d. The linear edge 30 extends along the side walls 12c and 12d to the front wall 12a, where an end length of the linear edge along the side walls 12c and 12d is angled upwardly proximate to each apex with the front wall 12a.

Front wall 12a, however, extends from the base 14 beyond the height of the linear edge 30 formed by walls 12b, 12c and 12d, allowing front wall 12a to prominently extend above the container 10. The upper edge 31 of front wall 12a varies in height across the front face of the container 10 so as to provide a shape to the front of the container 10. The shape provided to the container by upper edge 31 comprises an element of a scene 20 printed on the container, which is further discussed below.

An inner surface 13 of the container 10 includes inner surfaces 13a, 13b, 13c, and 13d corresponding to each side wall 12a, 12b, 12c and 12d. The inner surface 13 of the container 10 retains a liner 16 of a light reflective material, which may have various reflective properties, colorings and/or holographic patterning. In preferred embodiments, the light reflective material is a foil material having holographic patterning. The liner 16 is secured to the inner facing surfaces 13a-13d of side walls 12a-12d, and an inner surface of base 14 of container 10. Preferably, the liner 16 substantially covers the entire inner surface 13 of the container 10.

An outer surface 18 of the container 10 may be customized with a selected image or scene 20, where the scene 20 may be printed thereon and includes various design elements. Each wall 12a-12d of the container 10 is printed with a corresponding section of scene 20 such that scene 20 extends continuously around the outer surface 18 of the container. A ground engaging surface of the base 14 may also optionally be printed with a portion of the scene 20.

The container 10 incorporates the shape of the container walls 12a-12d and the printed scene 20 which includes colors, images, objects and other elements required to fully depict a selected environment. A plurality of corresponding apertures 22 contribute to produce an overall effect. Apertures 22 not only form integral elements of the scene 20, but also allow selected exposure of the inner surface 13, and thus the liner 16, of the container 10 and illumination of the scene 20 printed on the outer surface 18 of container 10 when the container 10 is illuminated and light reflected and manipulated by liner 16.

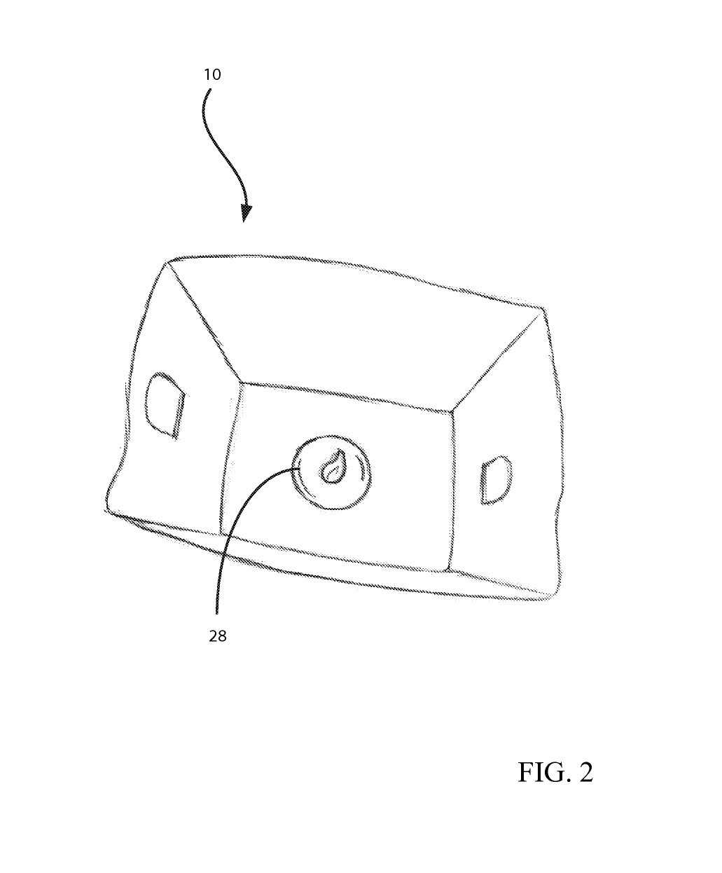

As further illustrated in FIGS. 1-2, the apertures 22, being of any one of a selected shape and/or size, are formed in one or more vertical side walls 12a-d of the container 10. The aperture shapes allow for customization of the container with the selected scene 20. The scene 20 as illustrated further in FIGS. 1-2 allows the container 10 to be a house or manor, or more specifically, a haunted house. The plurality of apertures 22 are in the shape of windows 24 and a door 26 creating the effect of a house with a view to an inside of the house. The apertures 22 are further adapted in shape such that objects appear partially in the windows 24 and door 26. For example a ghost, a pumpkin, a cat, bat and any other objects desired may be included in the shape of the aperture 22 to appear as situated in the aperture 24 or door 26. The scene 20 is printed such that the design and coloring of the container correspond to each specific aperture 22. Thus, the scene 20 provides outlines for the windows 24 and the door 26 and further provides coloring and images to appear as objects, such as floating ghosts, skeletons and landscapes along the walls to add details to the environment of the scene 20.

As the scene 20 extends around the container 10, FIG. 2 illustrates further apertures 22 in opposing side walls 12c and 12d. These side walls each include an aperture 22, in the shape of a window 24, to allow illumination to be reflected through the sides of the container 10. As noted above, the liner 16 is visible through each aperture 22 and as the inner surface 13d of back wall 12d is not adapted with apertures 22, the surface area of liner 16 on the inner surface 13 of the container 10 is sufficient provide a reflective surface and any holographic properties in proportion to the apertures 22 and open top of the container 10.

As illustrated in FIG. 2, a lighting unit 28 can be turned on to emit light which is further manipulated by the holographic or reflective inner liner 16 and emitted through the apertures 22 as well as the top of the container 10. When illuminated, the container 10 emits light and reflects the colors and patterns of the liner 16 through the front and side apertures. As illustrated in further detail in FIGS. 1-2, the outer design of the container 10 is also illuminated, providing a decorative effect having holographic effects and allowing the container 10 to also serve as a lighting unit for dark or dim areas.

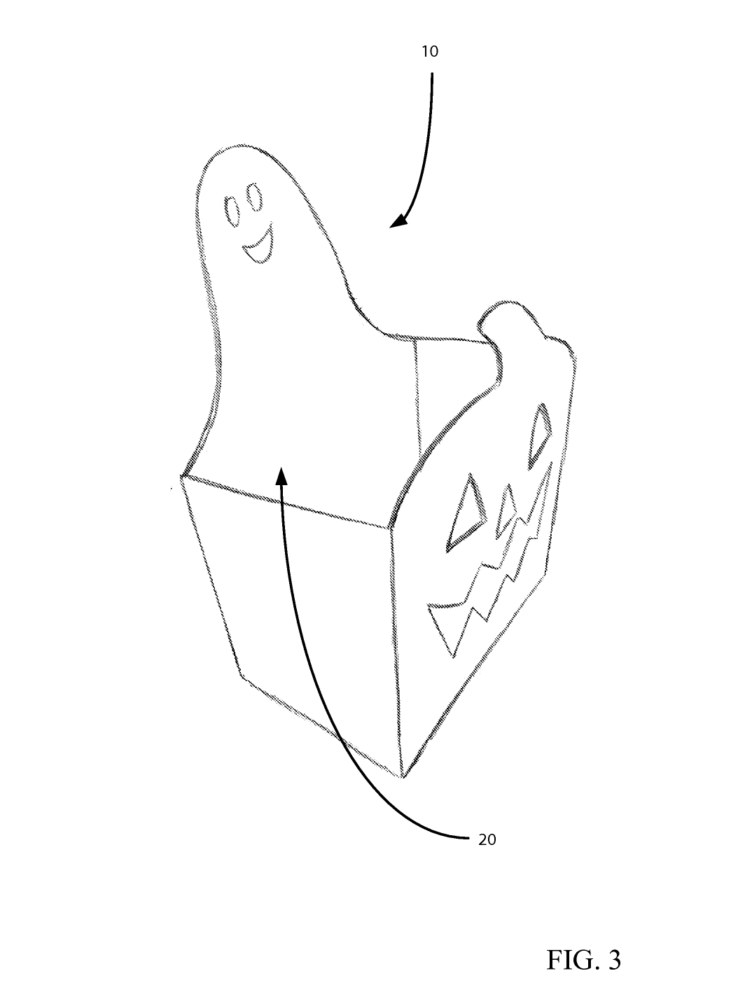

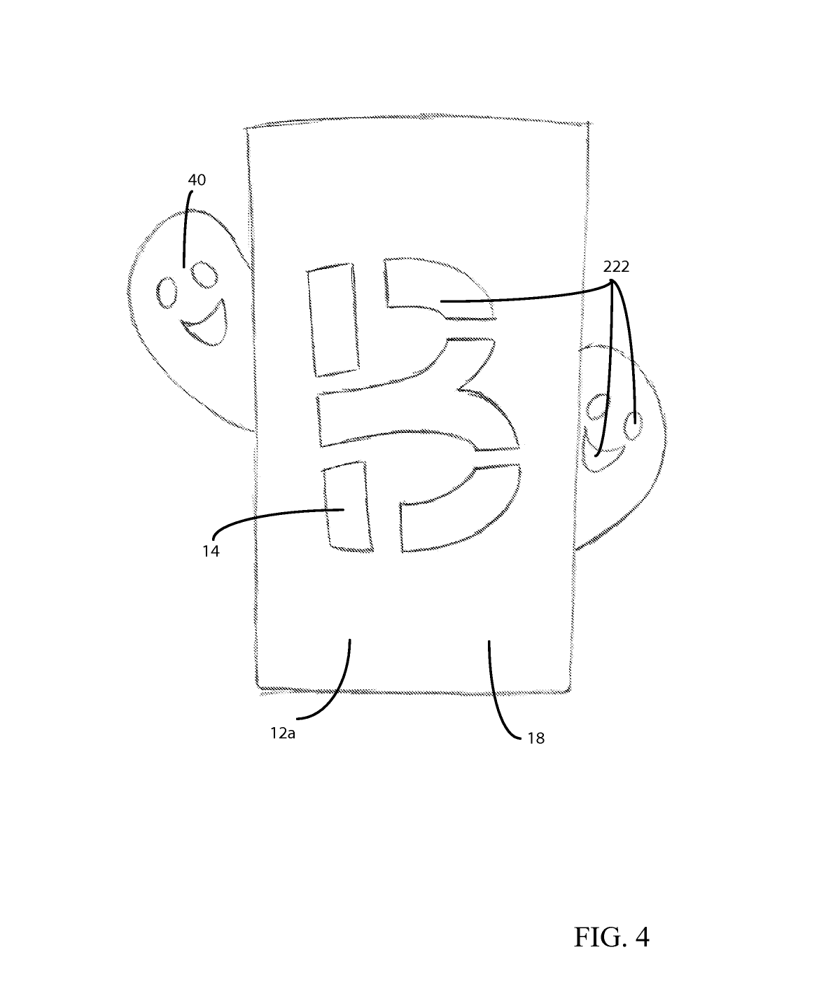

In an alternative embodiment, the overall effect of the container 10 may include a scene 20 configured to provide a unique dimensional aspect to the illuminable container 10. FIGS. 3-4 illustrate another example container 10 of the present disclosure. As shown, the container 10 of this embodiment includes a scene 20 applied to or printed onto the outer surface 18 of the container 10 and corresponding to apertures 122. The scene 20 is printed onto the front wall 12a of the container 10 and extends to side walls 12c and 12d. The scene 20 is continuous around the outer surface 18 of the container 10, but as the scene 20 includes ghost element in the rear of the container 10, the back wall 12b of the container 10 need not be printed, or alternatively, may be printed white have a white material applied thereto.

The scene 20 according to this embodiment includes a jack-o-lantern and a larger looming ghost behind the jack-o-lantern. The scene 20 is printed in color ink such that the objects in the scene are easily distinguishable. For example, the jack-o-lantern is printed in orange with appropriate shading for providing dimension to the jack-o-lantern and the stem portion of the jack-o-lantern is printed in green, again with appropriate shading.

Container 10 exhibits the dimensional aspect in part due to scene 20 including the printed design, wall shapes and corresponding apertures 122 and the overall shape of the scene 20. The scene 20 is visible on the front face 12a and is further augmented by the portion of the scene 20 protruding upwardly and visible on the rear wall 12b. As illustrated in FIGS. 3-4, when a dimensional aspect is incorporated into the illuminable container 10, the container 10 may not require the reflective and/or holographic inner liner 16. Although, in some embodiments, the container 10 of this embodiment may also incorporate liner 16 having holographic patterns, if desired.

As illustrated in FIGS. 3-4, vertical walls 12a-12d of the container 10 have varying heights and upper edge shapes. For example, side walls 12c and 12d extend upwardly from the base 14 to substantially the same height and terminate with a substantially linear upper edge 130 extending along from the front to the back of the container 10 along the side walls 12c and 12d. The linear edge 130 extends along the side walls 12c and 12d to the front wall 12a, wherein at the apex, or fold line, the upper edge 131 of the front wall 12a rises slightly above the side walls 12c and 12d. This allows front wall 12a to extend from the base 14 slightly above the height of the linear edge 130 formed by walls 12c and 12d. The upper edge 131 of front wall 12a varies in height across the front face of the container 10 so as to provide a shape to the front of the container 10.

As illustrated in further detail in FIGS. 3-4, the upper edge 131 of the front wall 12a is generally an arcuate length extending from side wall 12c to side wall 12d. The upper edge 131 is also adapted with an upwardly extending offset or slanted tab 33 located next to the center of the length of upper edge 131. Located next to a side wall, the upper edge 31 is also adapted with an upwardly extending arcuate length of smaller diameter 135. Portions 133 and 135 of upper edge 131 and upper edge 131 provide a shape to the front wall 12a of the container 10 that corresponds to the top perimeter of the jack-o-lantern (131) including a stem (133) and a hand of a ghost (135) resting on the jack-o-lantern. The shape of upper edge 131 thus corresponds to the portion of the scene 20 printed on the outer surface 18 of front wall 12a. As front wall 12a is printed with an image of a pumpkin, apertures 122 are generally positioned in the front wall 12a to form the jack-o-lantern by forming, for example, eyes, a nose and a mouth in the pumpkin design printed onto the container 10.

Further providing the dimensional aspect of the container 10 is the shape of and placement of the back wall 12b to the rear of the front wall 12a. The scene 20 extends to the inner surface 13b of the back wall 12b. The back wall 12b extends upwardly from the base 14 to a height above the front wall 12a. An upper portion 137 of the back wall 12b thus prominently protrudes above front wall 12a from behind front wall 12a such that back wall 12b is substantially unobstructed by the upper edge 131 of the front wall 12a. The upper portion 137 is visible above and to the rear of front wall 12a. The upper portion 137 of back wall 12b is formed by the upper edge 139 shape of the length of back wall extending from the apex or fold line at side wall 12c to the apex, or fold line at side wall 12d. The upper edge 139 first curves inwardly and upwardly with an arcuate length at the top of the curve and proceeds to curve outwardly and downwardly to proximate side wall 12d, such that the upper edge 139 provides an outline of an upright ghost figure as the upper portion 137. Back wall 12b is further adapted with apertures 122 positioned in the upper portion 37 to provide a face, including eyes and a mouth, to the upwardly extending ghost.

When illuminated, the container 10 allows light to be emitted through the apertures 122 in the front wall 12a of the container 10. Light is also emitted through the top of the container 10 and provides a dimensional aspect the container as the ghost is illuminated behind the jack-o-lantern.

In yet another embodiment, the container 10 may be configured with pop-outs 40. In this embodiment, the vertical walls 12a-12d extend integrally upwardly from the base 14 to substantially the same height such that the container 10 is substantially rectangular in shape along a vertical axis. The pop-outs are chads integrally formed in one or more vertical walls 12a-12d, allowing the liner 16 to be applied to one or more sides of the pop-out 40. Thus allowing the pop-out 40 to have reflective and/or holographic properties on at least one side.

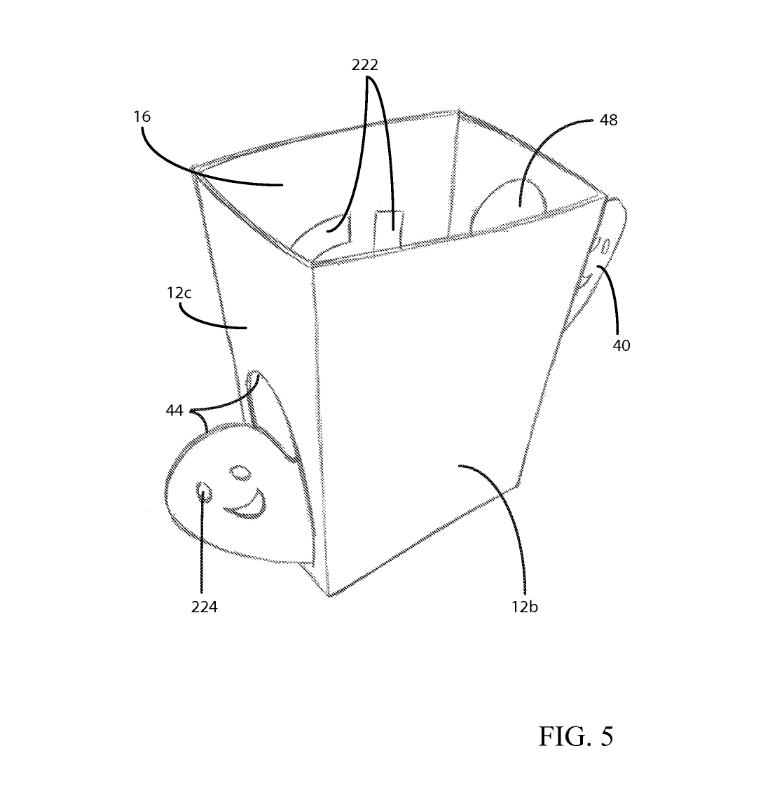

Front wall 12a is then adapted with apertures 222 which expose the liner 16 inside the container 10 and allow reflection of the light through the apertures 222. The reflective and/or holographic effect may then also be observed there through when the container is illuminated. The aperture 222 being a plurality of cut-out sections of the front wall 12a of the container 10, appears to form any one of an alpha numeric character. The characters include other symbols including punctuation and mathematical symbols. As illustrated in FIG. 5, the front wall 12a aperture 222 may, for example, be configured as character “B”, the letter “0” or an “!”. The opposing rear wall 12b is substantially free from apertures allowing the liner 16 visible through the apertures 222.

A plurality of containers 10 may also be assembled to form a larger cohesive scene 20. The larger scene may include multiple containers 10 arranged to spell a word or a phrase. Containers 10 may include a portion of a scene 20 such as a letter or a punctuation mark and may then be assembled or positioned proximate one another for an overall larger scene and illumination effect. Further, the pop-outs 40 may be folded out or stowed on the container 10. When multiple containers 10 are aligned, the position of the pop-outs 40 may be adjusted based on space or positioning of the containers 10, or on the overall scene 20.

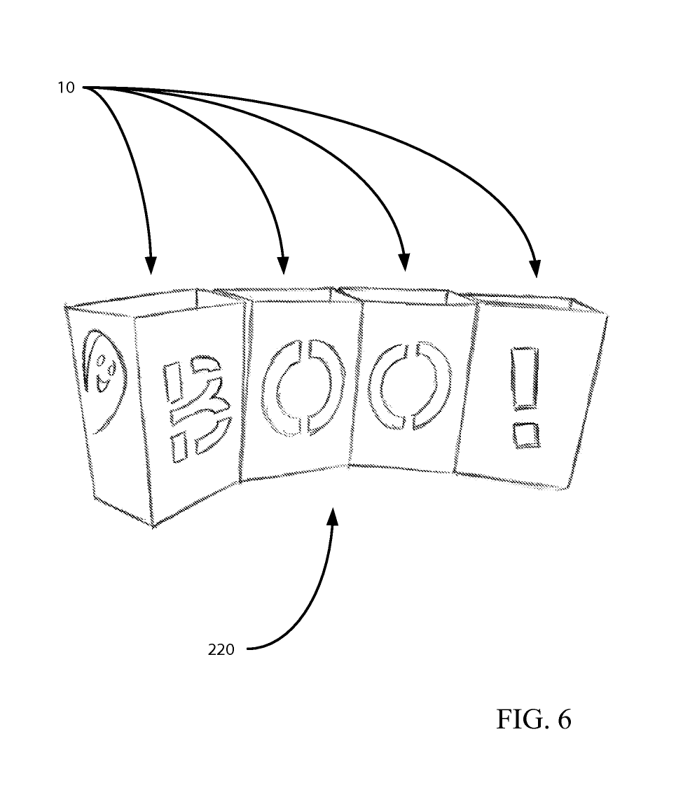

FIGS. 5-6 illustrate another example container 10 of the present disclosure, which includes pop-outs 40 on side walls 12c and 12d. The pop-outs 40 are holographic as the liner 16 is applied to the inner surfaces of the pop-outs 40. The pop-outs are cut from the side walls 12c and 12d and expose the inner surface 13c and 13d and thus the liner 16 when folded out. The pop-outs 40 are integrally formed in both vertical side walls 12c and 12d. A substantial portion of a perimeter 44 of a selected shape is cut from each vertical side wall. A perimeter section 46 of the pop-out 40 remains uncut and attached to the container 10 allowing the pop-out 40 to remain integrally attached to the container 10. This allows the pop-out 40 to be positionable between a stowed position as illustrated in FIG. 6, and a pop-out position as illustrated in FIG. 5.

The pop-outs 40 can be moved to the pop-out position by opening or folding out the pop-out 40. For example, folding the pop-out component 40 approximately 45 degrees from the plane of the side wall 12c or 12d will expose the inner surface of the respective side wall and thus the liner 16. The reflective and/holographic lined side of the pop-out 40 is exposed and extending outwardly from the side of the container 10. Further, when the pop-outs 40 are extended outwardly, corresponding openings 48 in the container 10 allow light to be emitted from the side walls 12c and 12d in addition to the front surface apertures 222 and the top of the container. The lighting unit 28 will further illuminate and reflect off the holographic pop-outs 40, providing a further enhanced illumination effect of the container.

As further illustrated in FIG. 5, the outer surface 18 of the container 10 includes a portion of the overall scene 20 wherein an opposing surface of the holographic pop-out 40 is printed with a design or color associated with the shape of the pop-out 40. For example, the pop-outs 40 are white on the outer surface as the pop-outs 40 are configured in the shape of a ghost. The holographic pop-outs 40 are further adapted with apertures 224 configured to form a face of the ghost like pop-out shape. The pop-outs may be configured in substantially any shape or design as relates to the scene 20. These apertures 224 allow limited light to be emitted from the side walls 12c and 12d when the pop-outs 40 are stowed. When stowed, the shape of the pop-out 40 forms a cohesive portion of the scene 20 and is a decorative element on the container 10. Further, the shape and design of the pop-out 40 distinguishes the pop-out 40 from the side wall 12c or 12d when stowed. When the pop-outs 40 are folded out, the pop-outs 40 are distinguished from the container in shape and color.

As further illustrated in FIGS. 5-6, a plurality of containers 10 can be aligned to form a cohesive, larger scene 220. For example, at least four containers 10 are arranged wherein the containers include apertures 222 in the form of the characters “B”, “O”, and “O”, and “!” respectively. The pop-outs 40 may selectively be popped out, with some or all pop-outs in the stowed position, depending on spacing or other considerations. When illuminated, the light is reflected through all the apertures 222 as well through any corresponding openings 48 to pop-outs 40 or apertures 224.

The containers described according to any one of the embodiments disclosed herein may be formed as discussed further below. The containers may be formed from a paper or paperboard material having sufficient paper density to withstand use and to support the container in an upright position. The container may be constructed from a heavy duty paper or similar material, for example, a card stock, tag board or even cardboard like material may be used.

A starting material for the container may then be printed on a first side with a design and shape selected for the assembled container. Alternatively, pre-colored starting material may be selected and cut to shape. Optionally, the holographic and/or reflective liner is adhesively adhered to a second, opposing side of the starting material. Alternatively, the liner may be laminated to the material or otherwise applied thereto.

Each container is cut from the starting material in a shape according to container specifications and assembled by folding and securing at least one vertical edge of a single piece of material. To do so, sheets or a continuous web of the lined and/or printed starting material may be die cut with a single die, or a plurality of dies in sequence, formed to cut the outline of the container assembly including any apertures, openings and/or pop-outs as well as all sides and securing tabs. Fold lines, and/or score lines, are also applied to the starting material and provide a guide for container assembly from the single cut piece. The fold and/or score lines may be provided to the starting material via any suitable method.

The container is then assembled by folding the cut sheet along pre-formed fold lines to form the vertical walls and the base. The close the container on all sides, two adjacent walls may be secured in the assembled configuration along a vertical seam. The base is formed by folding the sheet, which has been cut in a shape configured to form an envelope-like fold integrally forming the sides from the base. To secure the container, the seam may be positioned along the vertical length of the apex of, for example, a side wall and a back wall wherein one wall is adapted with an overhang for adhesive application. The overhang being folded and adhesively secured to the inside of an adjacent wall forms an adhesively secured corner and encloses the container on all sides. This allows the container to be assembled and adhesively secured along a seam, but also collapsible into a folded, flat unit. The container can be folded to a substantially flattened state, and assembled in the upright open position, which allows the container to be shipped and sold, as well as stored between uses in a folded and flattened state and then assembled to an upright and open position for use. Alternatively, to assemble the container, two vertical edges of the container may be adapted with corresponding tab and slot insert components, allowing the container to be completely unassembled and re-assembled for storage or transport.

Further, the light source 28 is replaceable within the container. The light source may be a candle, an LED candle, a battery operated light bulb of small size and wattage, a string of electric lights or any other suitable portable and/or self-contained illumination source.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the present disclosure. Although the present disclosure has been described with reference to preferred embodiments, workers skilled in the art will recognize that changes may be made in form and detail without departing from the spirit and scope of the disclosure.

1. A decorative illuminable container comprising:
a base configured to receive a light source;
a plurality of sidewalls extending upward from the base to define an interior region, wherein the sidewalls collectively define an outer surface and an inner surface for the container, and wherein the inner surface faces the interior region;
a reflective liner disposed on the inner surface;
a printed design applied to the outer surface; and
a plurality of apertures in at least one of the walls, wherein the plurality of apertures each have a shape that corresponds to the printed design applied to the outer surface;
wherein the container is configured to accept a light source in the interior region such that light from the light source reflects off the reflective liner and is emitted through the plurality of apertures.

2. The container of claim 1, wherein the reflective liner comprises a holographic liner such that a holographic pattern is visible through the apertures.

3. The container of claim 1, wherein at least a portion of the shapes of the plurality of apertures are different.

4. An illuminable container having a reflective inner surface and at least one aperture of a selected shape wherein the container is configured to receive a light source and the effect of the reflective inner surface and light emitted from the light source is visible through the at least one aperture.

5. An illuminable container having a visible dimensional aspect comprising:
a front vertical wall having a first shape and first height;
an opposing rear vertical wall of a second shape and a second, greater height different from the first shape and first height of the front wall and separated from the front wall by a horizontal base extending between the front and rear walls;
opposing vertical side walls connecting the front and rear walls, the side walls having a third shape and a third height, wherein the third shape and third height are different from both the first and second shapes and heights;
a plurality of apertures in at least one of the walls, wherein the plurality of apertures each have a shape that corresponds to a printed design applied to the least one wall;
a printed design applied at least one of the walls; and
wherein the base is configured to receive a light source to illuminate a space above the base and bounded by the walls such that design is illuminated and provides a dimensional aspect to the container.

6. The container of claim 5 wherein at least a portion of the shapes of the plurality of apertures are different.

7. An illuminable open-top container having a reflective inner surface and at least one aperture in a first vertical surface and at least one chad in a second, adjacent vertical surface wherein the container is configured to receive a light source and when illuminated the light reflected off of the inner surface is visible through the at least one aperture.

8. The container of claim 7, wherein the at least one chad comprises a reflective surface.

9. The container of claim 8 wherein the at least one chad is configured for folding outwardly from the vertical surface to expose the reflective surface.

10. The container of claim 9 wherein the light source is visible through an opening formed when the reflective surface of the chad is exposed.

11. The container of claim 8 wherein the at least one chad is configured for folding outwardly from the vertical surface of the container and a second chad is configured for folding outwardly from a second, opposing vertical surface of the container.

12. The container of claim 11 wherein the chads are selectively outwardly foldable.

13. The container of claim 7 where the character of the at least one aperture may be any one of an alphanumeric character.

14. The container of claim 7 wherein the reflective liner comprises a holographic liner such that a holographic pattern is visible through the apertures.

15. The container of claim 8 wherein the reflective liner comprises a holographic liner such that a holographic pattern is exposed on the chad.

16. The container of claim 13 further configured to be arranged and positioned with a plurality of like containers, each container having at least one aperture being any one of an alphanumeric character and the containers being arranged according to the apertures such that when each container is illuminated, a light source reflects off each reflective liner and is emitted through a respective aperture to illuminate the arranged apertures.
